(19) United States
(12) Patent Application Publication
(10) Pub. No.: US 2009/0197792 A1
(43) Pub. Date: Aug. 6, 2009

(54) Drip resistant acidic compositions for sprayable and non-sprayable application

(75) Inventors: Tapashi Sengupta, Barrington, IL (US); Gregory G. Plutko, Glen Ellyn, IL (US); Jerald W. Darlington, JR., Marengo, IL (US); Jason H. St. Onge, Geneva, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: AMCOL International Corporation, Hoffman Estates, IL (US)

(21) Appl. No.: 12/322,660

(22) Filed: Feb. 5, 2009

Related U.S. Application Data
(60) Provisional application No. 61/026,454, filed on Feb. 5, 2008.
(60) Provisional application No. 61/111,216, filed on Nov. 4, 2008.
(60) Provisional application No. 61/075,579, filed on Jun. 25, 2008.

(51) Int. Cl. C11D 17/00

(52) U.S. Cl. 510/418

(57) ABSTRACT

The present disclosure is directed to acidic cleaning compositions comprising 1 to 9% by weight of a layered phyllosilicate in surface modified sodium or protonated forms and pre-dispersed in pre-gel form with and without additives, 1 to 5% of an anionic surfactant, 2-10% of a hydrotope, 0.1-15% solvents, and at least one organic or inorganic acid as a pH-adjusting agent to provide a composition having a pH less than about 4.0. The compositions provide improved viscosity profile, sprayability, and drip resistance when applied to vertical surfaces.

### CROSS-REFERENCE TO RELATED APPLICATIONS

This application claims the benefit of provisional applications Ser. No. 61/075,579, filed Jun. 25, 2008; Ser. No. 61/026,454, filed Feb. 5, 2008; and Ser. No. 61/111,216 filed Nov. 4, 2008, all hereby incorporated by reference in their entirety.

### BACKGROUND

Acid containing cleaning compositions, e.g., lime scale removing formulations, cooking surface cleaners, ceramic tile cleaners, toilet bowl cleaning formulations, and drain pipe clog-removing formulations can be thickened with surface modified AMCOL clay pre-gels. Acid containing cleaning compositions with solvents and detergents are also used to dissolve and remove dirt, oil, grease, scum, and rust stains from concrete, ceramic tiles, porcelain bath fixtures and brighten and clean off oxidation. Sprayable products provide improved convenience, ease of use, and the ability to reach hard to access areas, and cleaning products that foam upon contact with the surface increase the surface area of coverage. Cleaning products are frequently applied to vertical surfaces, which results in dripping and reduced contact of the product with the soiled surface. Products that resist dripping would improve both the effectiveness of the cleaner by increasing the amount/concentration and duration of contact and reaction time between the cleaning product and the spill, and would improve convenience by reducing or eliminating dripping of the cleaning product. In addition, cleaning products are often formulated with volatile organic compounds (VOCs), and elimination or reduction of VOCs from cleaning compositions is desirable to reduce emissions and increase compliance with environmental regulations.

The present disclosure is directed to shear thinning, foaming, low pH, e.g., 0.1-4.0, preferably 0.1-1.0, compositions useful for cleaning and/or bleaching surfaces, such as vertical surfaces, and having improved resistance to dripping. Examples of surfaces that are cleaned using the present compositions include, but are not limited to, cooking surfaces and cookware, and particularly include cooking surfaces that are soiled with burnt on and/or baked on food and/or grease. Specific examples of such surfaces include, but are not limited to, ovens, grills, pots, pans, and stovetops, greasy kitchenware, utensils, countertops, vertical/horizontal concrete surfaces, ceramic tiles, toilet bowls, porcelain bath fixtures, oxidized surfaces, drain pipes, or other parts/machinery used in manufacturing factory areas.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Conventional cleaner compositions include inorganic particulates such as laponite (a synthetic hectorite) alone or in combination with polymeric thickening agents. The small size of laponite particles (about 1 to about 30 nm) has raised safety concerns regarding inhalation of fine nano particles provided in cleaning sprays. An alternative to laponite having larger particle sizes would be desirable to alleviate concerns related to particle size. In the present disclosure, purified AMCOL (smectite) clays having particles sizes in the range of about 0.05 μm to about 10 μm, preferably about 0.1 μm to about 5 μm, more preferably about 0.2 to about 2 μm are added to cleaning compositions to provide thickening properties.

The cleaning compositions described herein may or may not contain a hydrotope such as those selected from sodium xylene sulfonates, sodium cumene sulfonates, sodium toluene sulfonates, ethanol, isopropanol, propylene glycol, polyethylene glycol ethers, and/or alkyl polyglycosides and may or may not contain ingredients such as propoxy ethanol or propoxy propanol acting as preservatives and grease removers, and may or may not contain surfactants. Preferred clays include clays having a sheet-like or platey-structure, including layered phyllosilicates, such as smectite clay minerals, e.g., montmorillonite, particularly sodium montmorillonite; lithium montmorrillonite; magnesium montmorillonite and/or calcium montmorillonite; hectorite; bentonite; nontronite; beidellite; volkonskoite; saponite; sauconite; sobockite; stevensite; svinfordite; vermiculite; magadite; kenyaite and the like. Other useful layered materials include micaceous minerals, such as mica, illite, and mixed layered illite/smectite minerals, such as rectorite, tarosovite, ledikite and admixtures of illites with the clay minerals named above. Attapulgites and Sepiolites may also be preferably used for such applications. The clays comprise refined but unmodified clays, modified clays or mixtures of modified and unmodified clays. Modified clays include intercalated layered clay materials prepared by the cation exchange reaction of a water-swellable layered clay particle with an inorganic cation, such as a sodium, potassium, lithium, or ammonium compound, preferably a sodium compound, preferably an onium ion-liberating compound, to affect partial or complete cation exchange. Also, clays may be prepared by the cation exchange reaction to have protons as the counterions, as in AMCOL purified and protonated clays, for such low pH applications.

Intercalates are sold commercially as Nanomer® nanoclays (Nanocor, Inc.). Examples of suitable layered phyllosilicate clays include, but are not limited to, polymer grade (PG) montmorillonites such as PGN, PGW, and PGV clays (Nanocor, Inc.), PGL IX clay. Such polymer grade clays are purified in accordance with U.S. Pat. Nos. 6,050,509 and 6,596,803, hereby incorporated by reference in their entirety. Other clays such as Polargel NF, Attapulgites (Active Minerals sourced attapulgites, Engelhard attapulgites or from other sources), AMCOL montmorrilonite clays such as Grey Prassa, White Prassa, Peker, Lalapassa, CGS, DRB (exchanged or activated in the sodium form from their usual calcium/magnesium variety) can be used for more aesthetic, whiter rheology modifiers in home and personal care industries. Moreover, the clay minerals may have a wide range of CEC (cation exchange capacity) from 25 to 160 and may be partially in sodium/calcium/magnesium forms to provide the optimum rheology in different solvent mixtures. Mixtures of clays may be used and clays may be combined with one or more additives such as MMH mineral oxide/hydroxide for further development of viscosity. Also, clay pre-gels used in such applications may be dosed with an optical whitener such as titanium dioxide (0.2-0.3 microns), in the range 0.5-15% (w/w) based on clay, to provide a white colored formulation and whiter foam when dispensed on a substrate. It is also sometimes desired that the dried residue on any substrate be white to generate the right consumer perception/cue associated with any cleaner formulation. Optical whiteners such as pigmentary grade TiO₂ can help in providing such white residues when mixed with bentonites. Similarly, colored pigments or pearlescent pigments such as mica can be suspended very effectively in these formulations to obtain the desired aesthetics as these formulations have a very high viscosity at low shear. Colored pigments can also be simply dye-clay complexes, which may or may not exhibit pH dependent hues. Acids used in the formulation also help to partially bleach the phyllosilicates forming a lighter colored formulation at low pH compared to high pH with the same clay.

Cleaning compositions prepared with particulate laponite are known to drip profusely when applied by spraying onto a vertical or otherwise non-horizontal surface. In contrast, cleaner compositions of the present disclosure are drip resistant. As used herein, the term “drip resistant” means the cleaner composition does not drip immediately down a vertical surface when sprayed onto the vertical surface, and preferably does not drip for at least about 5 seconds, more preferably at least about 30 seconds, even more preferably at least about 1 minute, most preferably at least about 1 hour or more, after being sprayed onto the vertical surface.

The use of layered phyllosilicate clays, instead of particulate laponite, was found to dramatically improve the drip resistance of formulations comprising such clays. Suitable aluminosilicates may include counterions from the alkaline earth and alkali metal salts group such as sodium, potassium, lithium, magnesium, and/or calcium. Preferred cleaner compositions comprise about 0.5 to about 9% by weight of a layered phyllosilicate clay and about 0.1 to about 4% by weight of an anionic surfactant. In a specific example, the cleaner composition comprises about 1 to about 4% by weight of the layered phyllosilicate clay, 0.5 to about 5% anionic surfactant, and about 2 to about 10% by weight inorganic/organic acids, having a pH below about 4.0.

The present disclosure is also directed to cleaning compositions, comprising a layered phyllosilicate clay and an acid, weak or strong, inorganic or organic, such as HCl, phosphoric acid, phosphonic acid, sulfamic acid, oxalic acid, formic acid, citric acid, hydroxyacetic acid, nitrilotriacetic acids, malic acid, and the like, having resistance to dripping when sprayed on a non-horizontal surface. The use of layered phyllosilicate clays, instead of particulate laponite, was found to dramatically improve the drip resistance of formulations comprising such clays. Preferred cleaning compositions comprise about 0.5 to about 9% by weight of a layered phyllosilicate clay and sufficient acid to adjust the pH of the formulation to a pH of about 0.1 to about 4.0. In a specific example, the cleaning composition comprises about 1 to about 4% by weight of the layered phyllosilicate clay and sufficient sulfamic acid to adjust the pH of the formulation to less than or equal to 1.0.

The present disclosure is further directed to cleaning compositions, comprising a layered phyllosilicate clay, a hydrotope, and an acid, having resistance to dripping when sprayed on a non-horizontal surface. The use of layered phyllosilicate clays, instead of particulate laponite, was found to dramatically improve the drip resistance of formulations comprising such clays. Suitable acids can be weak or strong, organic or inorganic, such as HCl, phosphoric acid, phosphonic acid, sulfamic acid, oxalic acid, formic acid, citric acid, hydroxyacetic acid, nitrilotriacetic acids, malic acid and the like. Preferred cleaning compositions comprise about 0.5 to about 9% by weight of a layered phyllosilicate clay, about 0.1 to about 7% by weight of a hydrotope, and sufficient acid to adjust the pH of the formulation to a pH of about 0.1 to about 3.0. In a specific example, the cleaner composition comprises about 1 to about 4% by weight of the layered phyllosilicate clay, 2% to about 5% by weight of hydrotope and has a pH below about 3.0, preferably less than or equal to about 1.0.

The present disclosure is further directed to cleaning compositions, comprising a layered phyllosilicate clay, a hydrotope, a nonionic surfactant, and an acid, having resistance to dripping when sprayed on a non-horizontal surface. The use of layered phyllosilicate clays, instead of particulate laponite, was found to dramatically improve the drip resistance of formulations comprising such clays. Suitable acids can be weak or strong, organic or inorganic, such as HCl, phosphoric acid, phosphonic acid, sulfamic acid, oxalic acid, formic acid, citric acid, hydroxyacetic acid, nitrilotriacetic acids, malic acid and the like. Preferred cleaning compositions comprise about 0.5 to about 9% by weight of a layered phyllosilicate clay, about 0.1 to about 7% by weight of a hydrotope, 0.1-1% of a nonionic surfactant surfactant such as amine oxide, and sufficient acid to adjust the pH of the formulation to a pH of about 0.1 to about 3.0. In a specific example, the cleaner composition comprises about 1 to about 4% by weight of the layered phyllosilicate clay, about 2 to about 5% by weight of hydrotope, 0.1-0.4% amine oxide surfactant and has a pH below about 3.0, preferably less than or equal to about 1.0.

In the present disclosure, optional modifiers, including polymeric modifiers, are added to obtain formulations comprising silicate, and having a pH below about 4.0, preferably below about 3.0, and more preferably less than or equal to about 1.0, with resistance to dripping. Examples of suitable polymeric modifiers include, but are not limiting to, high salt tolerant polymers, such as xanthan gum, guars or cellulosics, nonionic cellulosic polymers, and cationic guar/xanthan. At lower solids content, the off-white color of formulations and foams can be mitigated due to reduction in light scattering by fewer micron size particles. Resistance to dripping at low pH (below about 3.0) is also obtained by preparing formulations comprising high amounts of aluminosilicate clays (1.5-9%).

Resistance to dripping at low pH (below about 3.0) is obtained by preparing formulations comprising high amounts of aluminosilicate clays (1.5-9%). If a lower solids level is desired, then the viscosity of such formulations also can be increased at low pH by adding a small amount of positively charged particles/ingredients such as mixed metal hydroxides (MMH), alumina, titanium dioxide, cationic polymers, cationic surfactants or amine oxide type nonionic surfactants to interact with the negatively charged basal planes (clay platelet surfaces) of the clay particles and thereby help in boosting the network structure.

The formulation of the present disclosure optionally comprises various additives. These additives include anionic surfactants such as SLS (sodium lauryl sulfate), linear alkyl benzene sulfonates, lignosulfonates, phosphonates, laureth sulfates, nonionic salt and acid tolerate surfactants such as amine oxide surfactants (e.g. lauramine oxide); hydrotopes, such as sodium xylene sulfonates, sodium cumene sulfonates, sodium toluene sulfonates, ethanol, isopropanol, propylene glycol, polyethylene glycol ethers, and/or an alkyl polygluosides; corrosion inhibitors; preservatives such as propoxy ethanol or propoxy propanol, pH-adjusting agents; non-VOC organic solvents, such as ethylene glycol phenyl ether (Eph) and dipropylene glycol butyl ether (DPnB) as grease removers; and organic/inorganic acids.

The preferred formulations of the present disclosure are also substantially free (less than 2%, more preferably less than 0.5%) from volatile organic compounds. Volatile organic compounds are defined by the U.S. Environmental Protection Agency in the Code of Federal Regulations as any compound of carbon, excluding carbon monoxide, carbon dioxide, carbonic acid, metallic carbides or carbonates, and ammonium carbonate, which participates in atmospheric photochemical reactions. The formulations of the present disclosure comprise less than about 8% by weight of volatile organic compounds, preferably less than about 5% by weight of volatile organic compounds, more preferably less than about 2% by weight of volatile organic compounds, most preferably less than about 0.5% by weight of volatile organic compounds. Non-VOC organic solvents that may be used in such formulations are Dow Chemical Corporation P-series glycol ether solvents and E-series glycol ether solvents. The glycol ether solvents used in cleaner formulations as effective degreasers may be ethylene glycol phenyl ether (Eph), dipropylene glycol butyl ether (DPnB), propylene glycol butyl ether (PnB), Tripropylene glycol butyl ether (TPnB), Dipropylene glycol propyl ether (DPnP), Propylene glycol phenyl ether (PPh).

### SUMMARY

Low pH cleaner formulations containing either inorganic or organic acids such as HCl, phosphoric acid, phosphonic acid, sulfamic acid, oxalic acid, formic acid, citric acid, hydroxyacetic acid, and/or the like (as in lime scale removing formulations, toilet bowl cleaner formulations, or clog removing acidic formulations in drain pipes) can be thickened by appropriate surface modified AMCOL aluminosilicates with a cation exchange capacity (CEC=25-160 meq/100 gm), which are inert at acid concentrations as high as 10% (w/w).

The compositions and methods described herein include one or more of the following features (a)-(d): (a) thickening acid formulations with natural, non-toxic, and inert rheology modifiers; (b) rendering the thickened formulations shear thinning and sprayable on horizontal or vertical surfaces; (c) rendering the thickened formulations thixotropic, by virtue of which the formulations can be sprayed on to a vertical surface to provide non-dripping foam and vertical cling; and/or (d) boosting the removal of lime-scales or divalent or trivalent metal ions (as in rust) by simply exchanging with the proton or the sodium on the aluminosilicates contained in the cleaning formulations described herein.

AMCOL aluminoslicate pregels AMCOL A, AMCOL B, AMCOL V, and AMCOL PGL, which are purified and surface modified smectite clays in sodium form, provide high viscosity to the formulations at a solids concentration of 2-5% (w/w) and can be used as excellent rheology modifiers. The same aluminosilicates at solids contents of 3-5% (w/w) in the low pH formulations described herein help in providing vertical cling and non-dripping foam.

Whitened versions of the same aluminosilicates containing 4-15% (w/w) TiO₂ on aluminosilicate provide slightly more viscous formulations than the corresponding non-whitened forms. This is due to the increased inter-particle interactions among the negatively charged aluminosilcate particles and positively charged TiO₂ pigment particles at the low pH of the formulation. At very high loading of TiO₂, some flocculation and instability may be expected. An optimum amount of TiO₂ may be around 4-8% (w/w) on aluminosilicates solids.

AMCOL (A+C), AMCOL (B+C), and AMCOL (V+C) pregels can be also used to thicken low pH formulations at 2-5% (w/w) solids level very effectively where C refers to the positively charged MMH particle additive.

Special protonated versions of surface modified AMCOL pregels, AMCOL HA, AMCOL HB, AMCOL HV can also be used alone or together with the sodium versions of the same pregels to provide the desired viscosity and the foam characteristics. The protonated versions of AMCOL aluminosilicates can build a gel-like structure due to hydrogen bonding, which can be broken by vigorous shaking or during spraying under shear. The mixture AMCOL HA+AMCOL A, and AMCOL HV+AMCOLV exhibit superior performance in terms of viscosity building and non-drip foam producing ability. When sodium versions of surface modified aluminosilicates are used in such highly acidic formulations, these will undergo surface protonation to some extent and exist in equilibrium with the sodium versions, in the presence of excess acids.

Protonated AMCOL aluminosilicates have been shown to have anti-microbial (anti-viral and anti-bacterial) properties in patent application Ser. No. 11/196,090, filed Aug. 3, 2005, hereby incorporated by reference, and may be used at 2-3% (w/w) solids level with a hydrotope (such as sodium xylene sulfonate) to create a sprayable, anti-microbial, and a non-dripping foam on a surface. This formulation can be further thickened with 0.1-1% (w/w) of one or more nonionic surfactant such as an amine oxide surfactants (Lauramine oxide) to provide a thicker non-dripping foam on a substrate.

When a hydrotope is used in the same low pH formulations together with AMCOL aluminosilicates, the spray pattern becomes narrow and uniform leaving creamy concentrated foam on any vertical substrate, which concentrates the active and helps in promoting more efficient cleaning of the substrate.

The low pH formulations can be further thickened at slightly lower levels (2-3%) of AMCOL aluminosilicate solids with 0.1-1% amine oxide surfactants. Amine oxide surfactants can help in building very high viscosity of the formulations in the presence of AMCOL aluminosilicates.

AMCOL FLT, a high salt tolerant aluminosilicate, can be also used to provide high viscosity to the formulations and non-dripping foam at a solids concentration of 6-9% (w/w) in the formulation.

### BRIEF DESCRIPTION OF THE DRAWINGS

FIG. 1A is a graph showing viscosity profiles of the low pH acid formulations (low shear region only) prepared with AMCOL A and AMCOL B aluminosilicate pregels in sodium and protonated surface modified forms, as in Formulas #1 and 2;

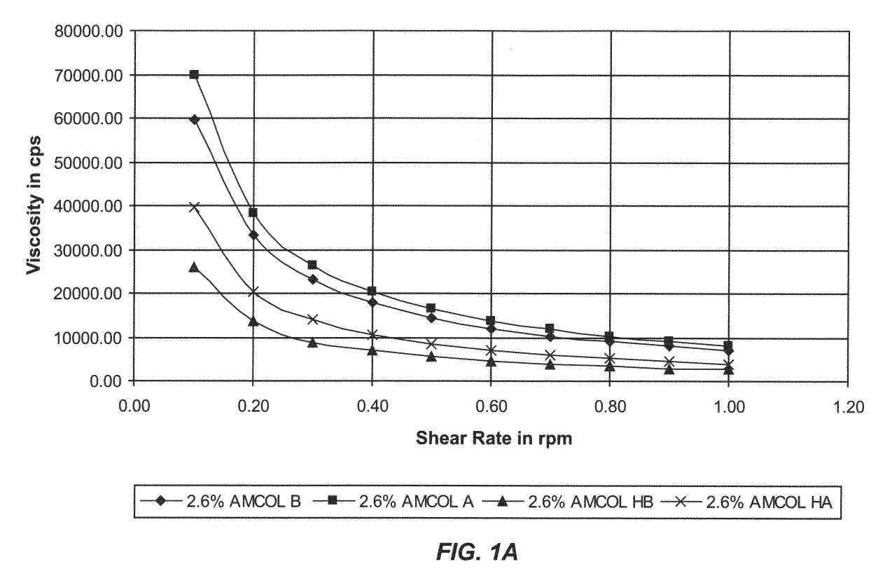

FIG. 1B is a graph showing viscosity profiles of the low pH acid formulations (Formulas #1, 2) prepared with AMCOL A and AMCOL B aluminosilicate pregels in sodium and protonated surface modified forms, over the entire range of shear rates;

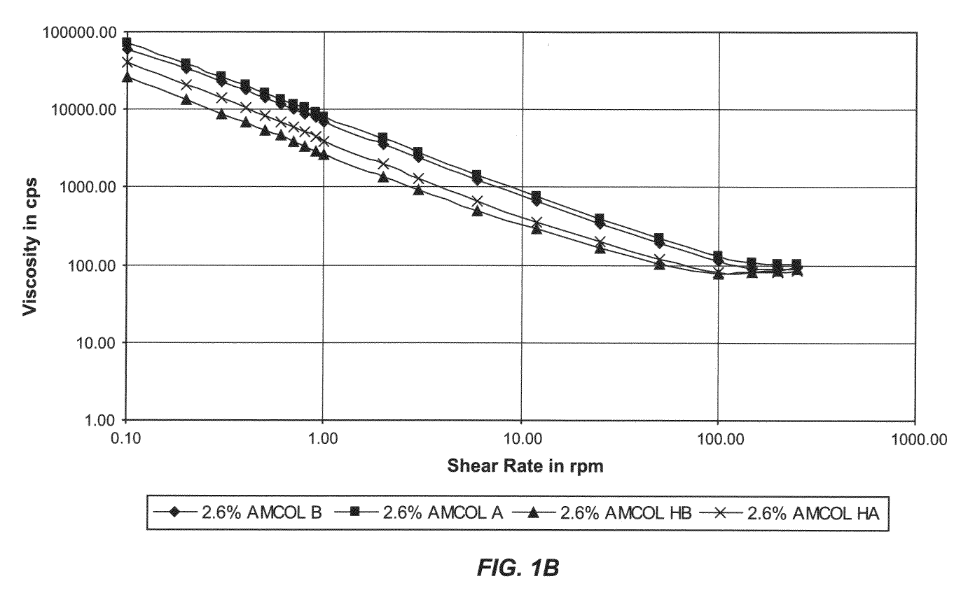

FIG. 2A is a graph showing viscosity profiles of protonated forms (Formulas #2, 3), sodium forms (Formulas #1) and their mixtures of AMCOL B surface modified aluminosilicate pregels in low pH formulations, over the entire range of shear rates;

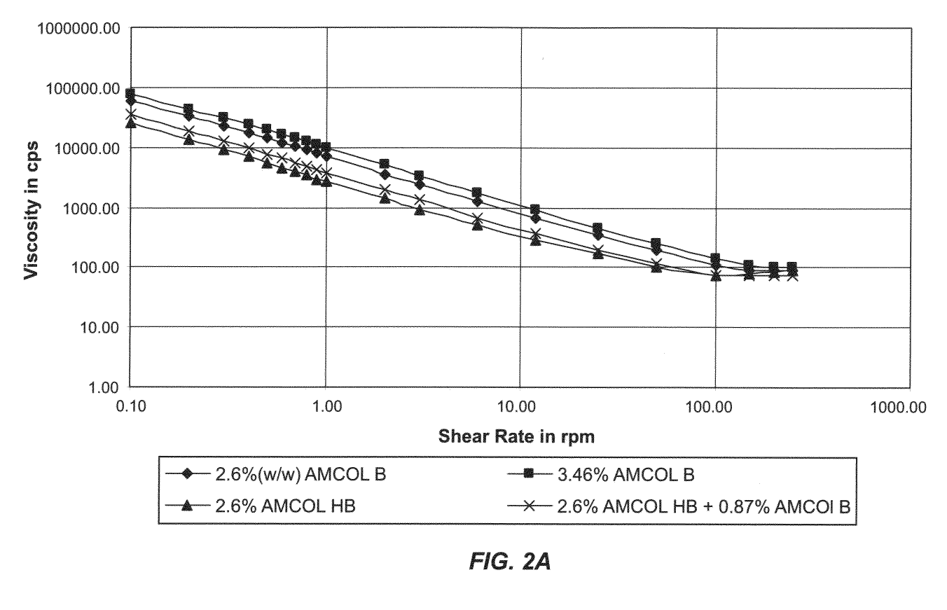

FIG. 2B is graph showing viscosity profiles of low pH formulations with protonated forms (Formulas #2, 3), sodium forms (Formulas #1) and their mixtures of AMCOL A surface modified aluminosilicate pregels, over the entire range of shear rates;

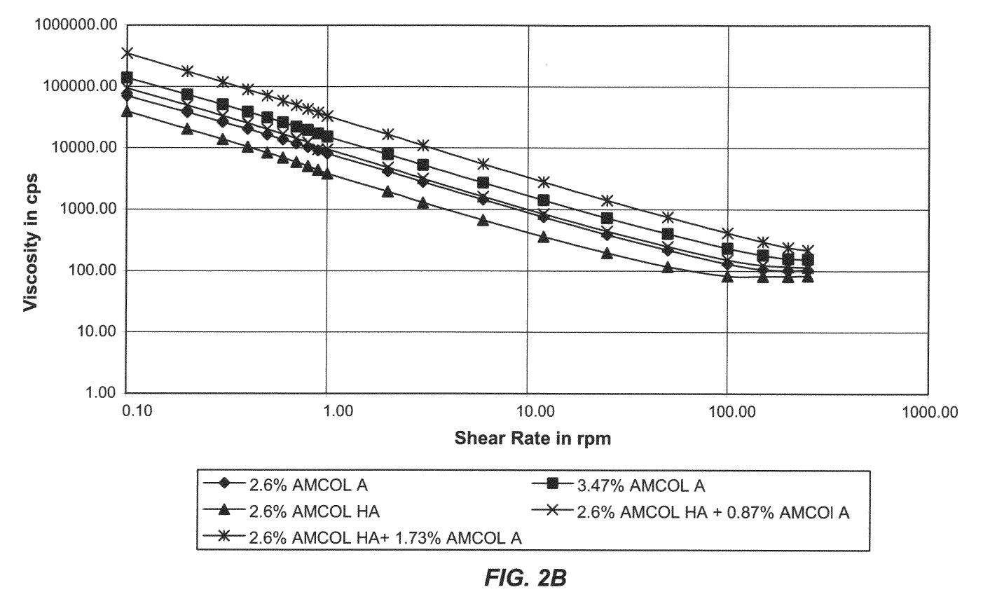

FIG. 3 is a graph showing viscosity profiles of low pH formulations with AMCOL FLT aluminosilicate pregels over the entire range of shear rates (Formula #1 with different aluminosilicate solids levels);

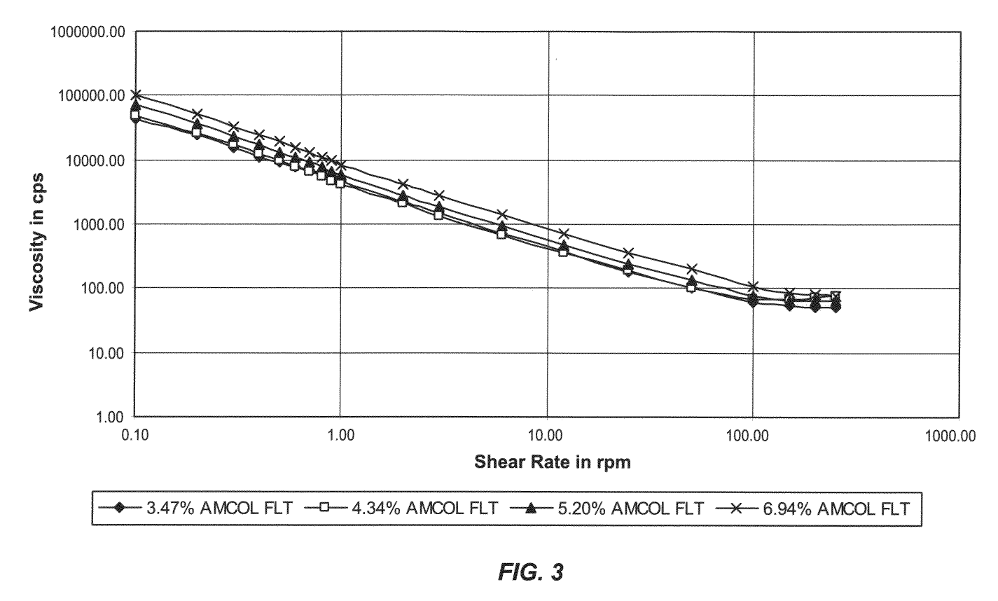

FIG. 4A is a graph showing viscosity profiles of low pH formulations with AMCOL A and AMCOL B aluminosilicate pregels, as is and with TiO₂, over the entire range of shear rates;

FIG. 4B is a graph showing viscosity profiles of low pH formulations with AMCOL A, AMCOL V, and AMCOL B aluminosilicate pregels, over the entire range of shear rates;

FIG. 5 is a graph showing viscosity profiles of low pH formulations with AMCOL A aluminosilicate pregel and different ingredients as in Formulas #4, 5, and 6 and AMCOL (A+C) in Formula #9 over the entire range of shear rates;

FIG. 6 is a graph showing viscosity profiles of low pH formulations with AMCOL HA, AMCOL HV aluminosilicate pregels, over the entire range of shear rates;

FIGS. 7A-7D are color photographs showing the non-drip feature of the low pH formulations containing 2.6% AMCOL A; V; B and A+C on a vertical surface;

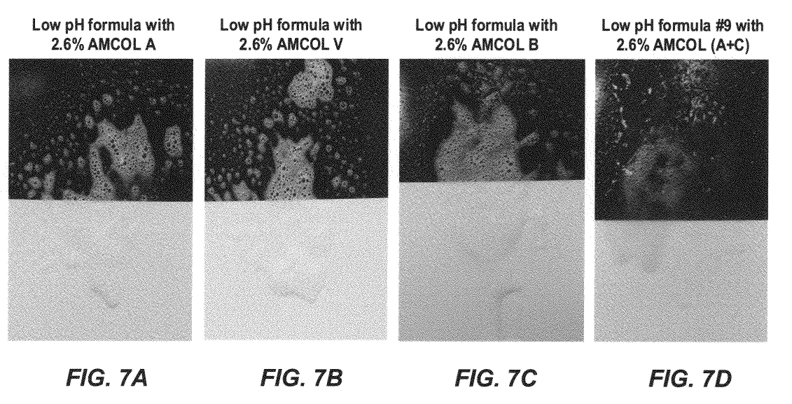

FIGS. 8A-8D are color photographs showing the non-drip feature of the low pH formulations containing 3.47% AMCOL A; V; B and 3.47% laponite;

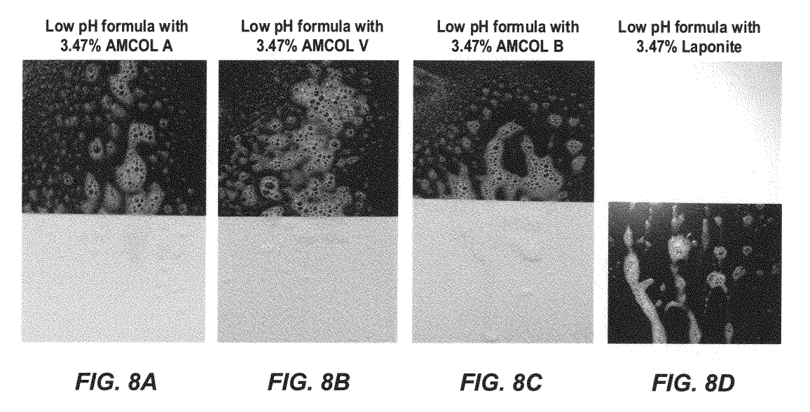

FIGS. 9A-9C are color photographs showing the non-drip feature of the low pH formulations containing 2.6% AMCOL HB; HA; and 2.6% AMCOL HA and 1.73% A;

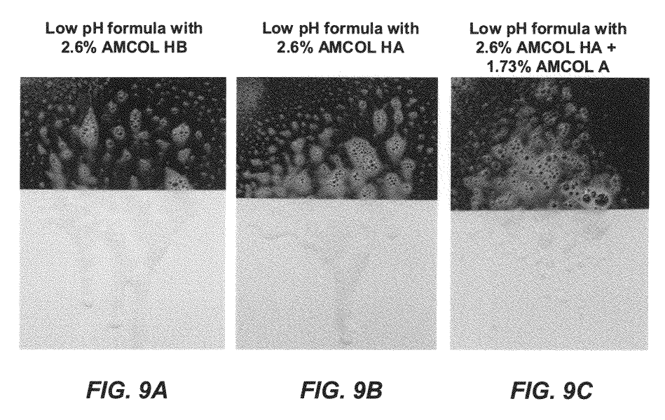

FIGS. 10A-10C are color photographs showing the non-drip feature of the low pH formulations containing 3.47% AMCOL A with Ti0₂; 3.47% AMCOL B with Ti0₂; and 8% AMCOL FLT with Ti0₂.

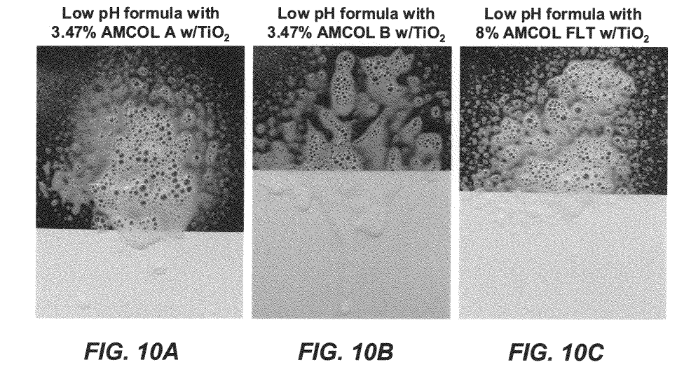

FIGS. 11A-11D are color photographs showing the non-drip feature of the low pH formulations containing formula #7 with 2.6% AMCOL HA; HV; and formula #8 with 2.6 AMCOL HA; HV;

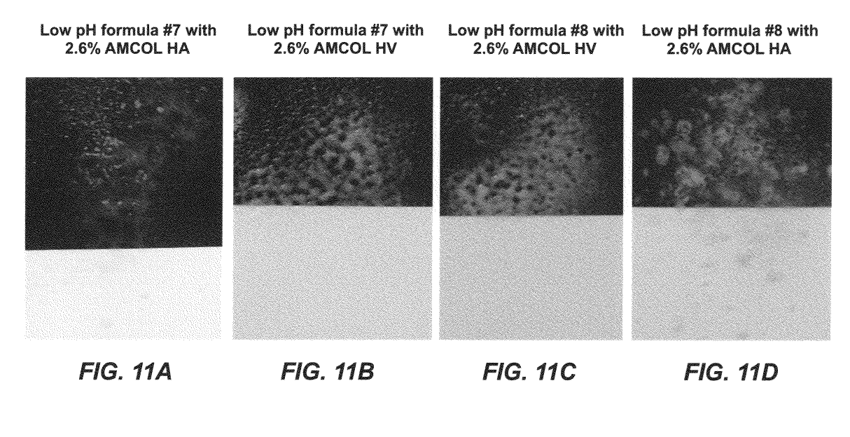

FIGS. 12A-12D are color photographs showing the non-drip feature of the low pH formulations containing formula #4 with 3.47% AMCOL A; formula #5 with 3.47% AMCOL A; formula #6 with 3.47 AMCOL A; and low pH formula with 8% AMCOL FLT and Ti0₂;

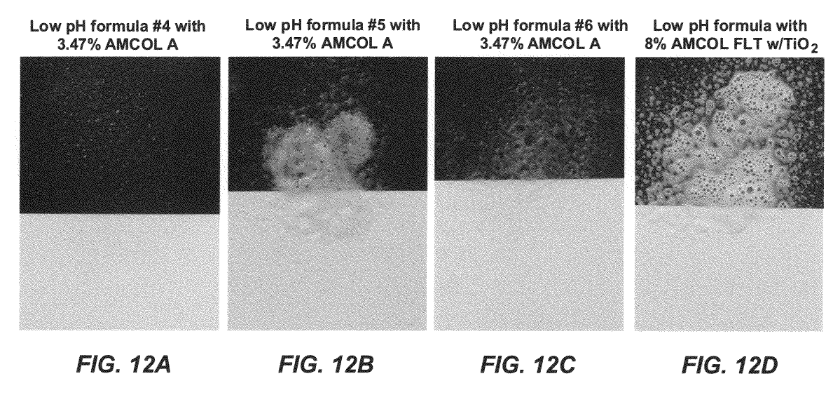

FIG. 13 is a graph showing viscosity of AMCOL clays and synthetic clay at low shear and over a wide range of solution pH;

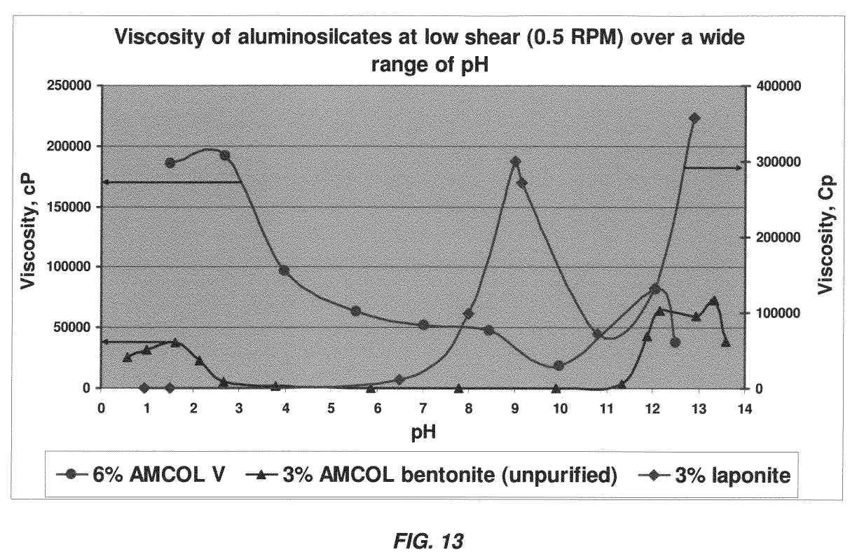

FIG. 14 is a graph showing degree of shear thinning of AMCOL clays and synthetic clay over a wide range of solution pH;

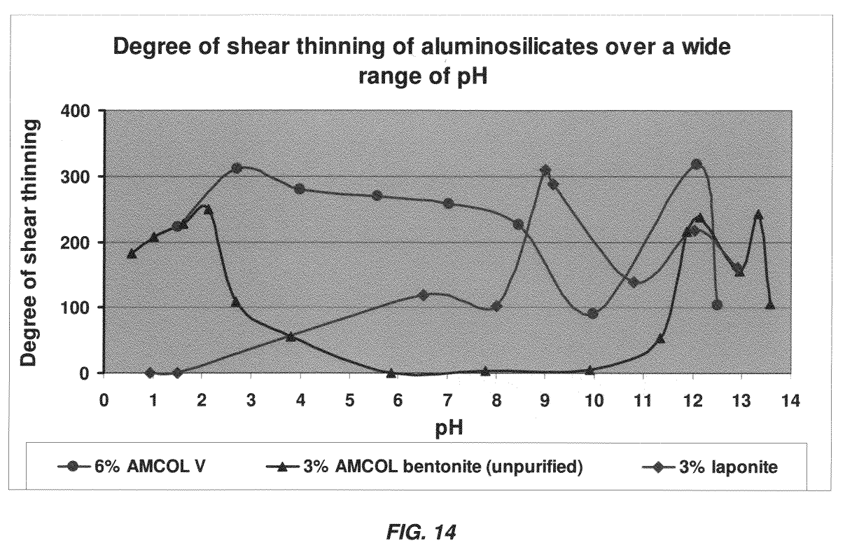

FIG. 15 is a graph showing effect of salt and ionic strength on AMCOL clays and synthetic clay; and

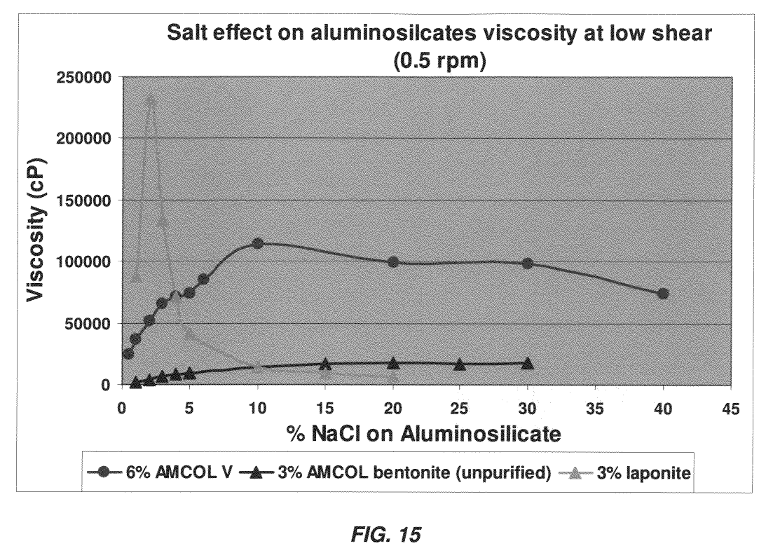

FIG. 16 is a graph showing degree of shear thinning of AMCOL clays and synthetic clay over a wide range of salt concentration.

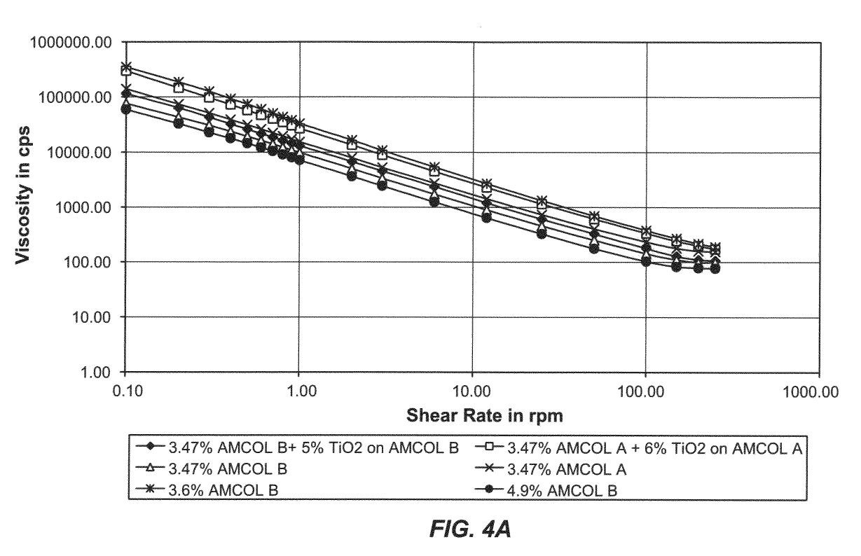

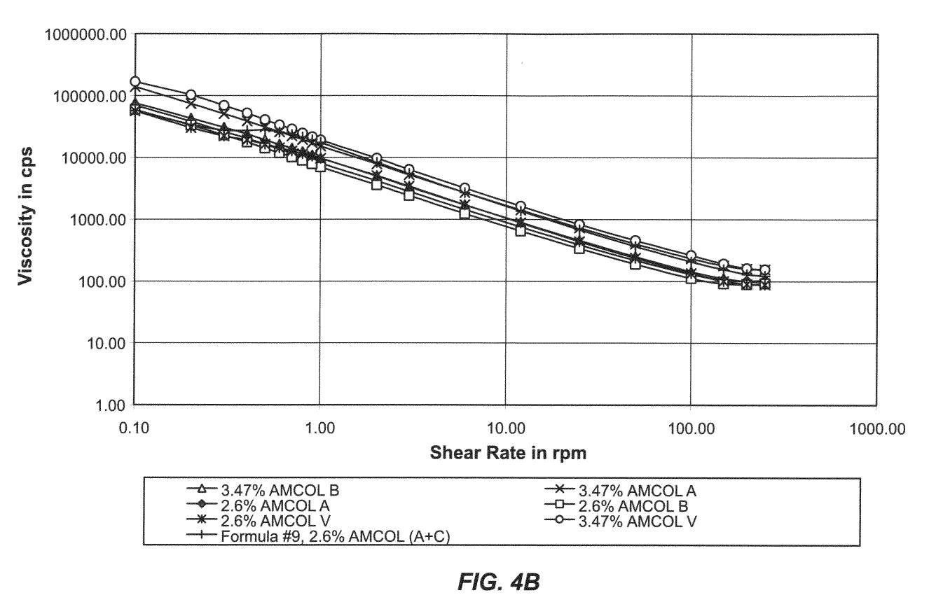

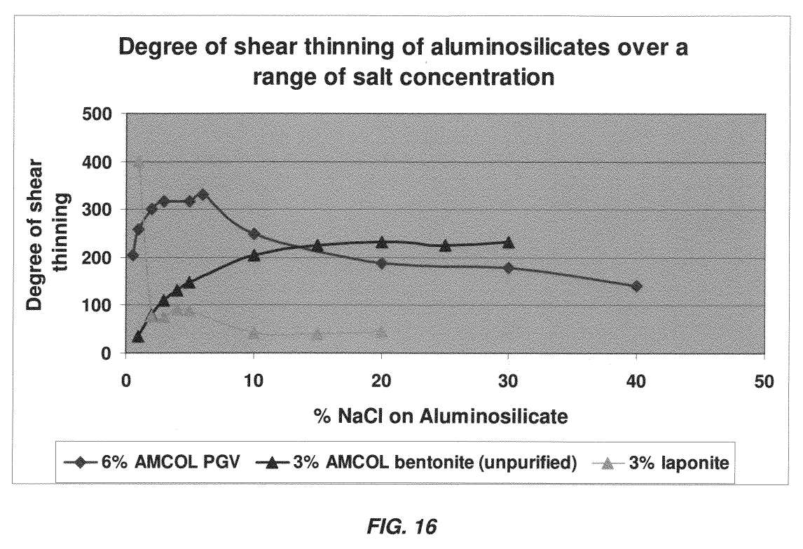

Based on FIG. 4A, it is clear that addition of Ti0₂ helps in boosting the viscosity of the low pH formulations for both AMCOL A and AMCOL B based pregels. This is due to the increased inter-particle interactions among the negatively charged aluminosilcate particles and the positively charged Ti0₂ pigment particles at the low pH of the formulation. At very high loading of Ti0₂, some flocculation and instability may be expected. An optimum amount of Ti0₂ may be around 4-8% (w/w) on aluminosilicates solids. From FIG. 4B it is also evident that AMCOL V>AMCOL A>AMCOL B in developing viscosity of these low pH formulations. Also Formula #9 with 2.6% AMCOL (A+C), sulfamic acid, sodium xylene sulfonate is represented in the same FIG. 4B, demonstrating the effectiveness of the additive C in building viscosity at low clay solids levels and at low pH.

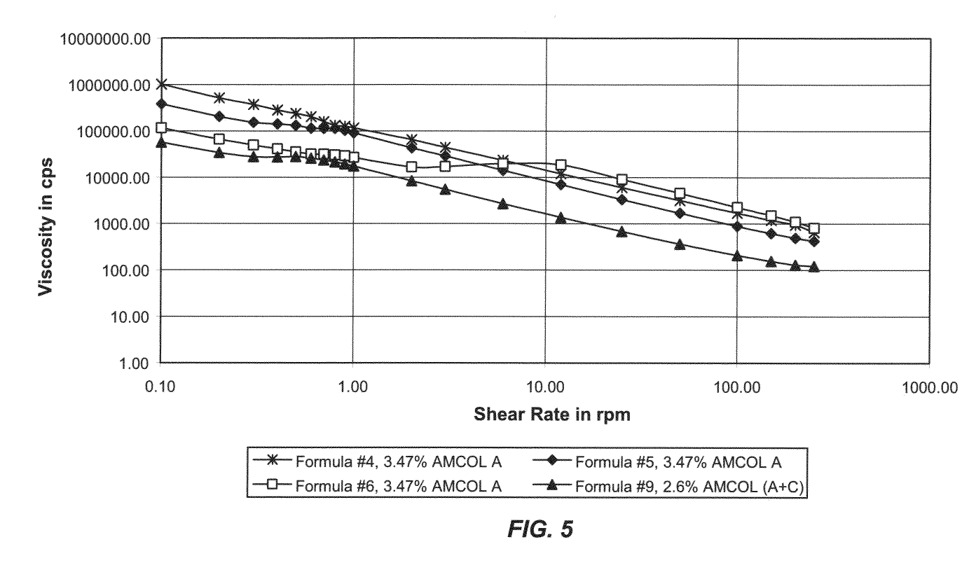

FIG. 5 represents Formulas #4, 5, and 6 with AMCOL A pregel using only sulfamic acid, sulfamic acid and sodium xylene sulfonate, and sulfamic acid, sodium xylene sulfonate, amine oxide surfactant respectively. No other surfactants were used in this formulation. Also Formula #9 with 2.6% AMCOL (A+C), sulfamic acid, sodium xylene sulfonate is represented in the same FIG. 4B, demonstrating the effectiveness of the additive C in building viscosity low clay solids levels and at low pH. The second slope in the low shear region of Formulas #6 and 9 in FIG. 5 may be attributed to the additional network formation among flocs formed between additives and clay particles. The flocs have been formed due to the additive amine oxide surfactant in Formula #6 and additive C in formula #9. The clay particles in AMCOL A based formulations in the absence of additives as in Formulas #4 and 5 form only one type of network structure.

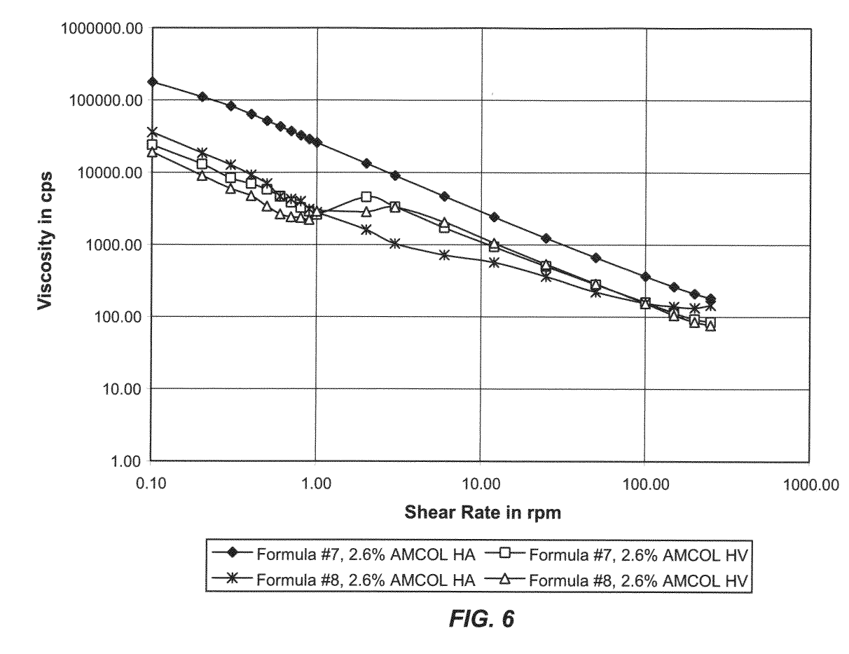

FIG. 6 represents the Formulas #7, 8 with AMCOL HA and AMCOL HB pregels with sodium xylene sulfonate alone and sodium xylene sulfonate, amine oxide surfactant respectively. No other acids or surfactants were used in these formulas since these formulas represent more of the anti-microbial formulas for sanitizing purposes.

In FIG. 6, it is evident that AMCOL HA builds viscosity by only one type of mechanism for network formation, as revealed by a mostly single slope of the plots for HA containing formulations. A small secondary slope is, however, noticeable in Formula#8 with AMCOL HA due to the small extent of flocculation induced between the amine oxide surfactant and the AMCOL HA particles.

However, for AMCOL HV based formulations #7 and 8, there are two distinct slopes in the log-log plots indicating that two types of mechanisms are operational in the formation of the network structure. The second slope in the low shear region is also more pronounced for Formula #8, where flocculation between the amine oxide surfactant and the protonated clay particles occurs and the second slope is indicative of this secondary structure between the flocs. The second slope in the low shear region for Formula #7 containing AMCOL HV only may be due to interactions among the flocculated clay particles themselves under low pH conditions.

### DETAILED DESCRIPTION

Examples of some formulations with different surface modified AMCOL aluminosilicate pregels are given below. Formula #1 can be prepared by first mixing AMCOL aluminosilicate pregel and water with a Silverson L4R rotor/stator mixer at 1000-3000 rpm. Phase #2 is then added to the phase #1 dispersion at 400-500 rpm, until complete dissolution. Phase #3 ingredients are then added and mixed to a homogenous mixture.

Formula #1 - 3.47% (w/w) AMCOL A based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 6 | 3.47 | 57.83 | |
| | (6% AMCOL A) | | | | |
| 2 | SLS | 100 | 0-3 | 0-3 | |
| 3 | Sulfamic acid | 99 | 4-9 | 4-9 | |
| 3 | Oxalic acid | 98 | 0-3 | 0-3 | pH < 1 |
| Total | | | | 100 | |

Formula #1 provides a low pH formulation, which can be sprayed on to a vertical substrate to form non-dripping foam. The formulation clings to the surface, increasing the contact time with the acids and the substrate. Formula #1 can be formulated with 2-5% (w/w) of surface modified AMCOL aluminosilicate pregels AMCOL A, AMCOL B, AMCOL V, AMCOL PGL. A higher solids content around 6-8% (w/w) is required for AMCOL FLT to provide a high viscosity and stability to the formulation. Formula #1 can be prepared with HCl, phosphoric, phosphonic, hydroxyacetic, sulfamic, citric, NTA (nitrilotriacetic acid), oxalic, formic or other organic acids. AMCOL A, AMCOL V>AMCOL B, for good non-dripping foam characteristics. Highly flocculating clays do not perform as well as the less flocculating ones in low pH formulations in terms of stability or viscosity or thixotropy. More flocculated systems can generate the low or high shear viscosity, but may not have the high temperature stability. Therefore, the size, surface charge, distribution of charge, charge density of clay particles and the size and type of flocs play an important role in determining which type of clay will be useful in such formulations.

Formula #2 - 2.6% (w/w) AMCOL HA based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 3 | 2.6 | 86.7 | |
| | (3% AMCOL HA) | | | | |
| 2 | SLS | 100 | 0-3 | 0-3 | |
| 3 | Sulfamic acid | 99 | 4-9 | 4-9 | |
| 3 | Oxalic acid | 98 | 0-3 | 0-3 | pH < 1 |
| Total | | | | 100 | |

Formula #2 can be prepared with surface modified AMCOL aluminosilicate pregels AMCOL HA, AMCOL HB, or AMCOL HV to provide a low pH formulation, which can be sprayed on to a vertical substrate to produce slightly dripping foam. However, these foams are significantly better in dripping characteristics, compared to that produced with 3.47% (w/w) laponite in the formulation as in Formulation #5. Also, when AMCOL HA is mixed with AMCOL A pregels as in Formula #3 below, the foam on the vertical substrate again becomes non-dripping.

Formula #3 - 4.34% (w/w) AMCOL HA + A based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 5 | 4.34 | 86.7 | |
| | (3% AMCOL HA + | | | | |
| | 2% AMCOL A) | | | | |
| 2 | SLS | 100 | 0-3 | 0-3 | |
| 3 | Sulfamic acid | 99 | 4-9 | 4-9 | |
| 3 | Oxalic acid | 98 | 0-3 | 0-3 | pH < 1 |
| Total | | | | 100 | |

The protonated versions of AMCOL A, AMCOL B or AMCOL V also follow the same trend in terms of drip characteristics: AMCOL A, AMCOL V>AMCOL B. The protonated versions of the aluminosilicate pregels help in building a loosely connected gel structure in the formulation via hydrogen bonding, which can be converted to a fluid by shaking the formulation. The protonated versions of AMCOL aluminosilicates help to suppress the electrolyte content of the formulations and can exchange with the divalent or trivalent ions from the substrate.

FORMULA #4 - 3.47% (W/W) AMCOL A BASED

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 6 | 3.47 | 57.83 | |
| | (6% AMCOL A) | | | | |
| 3 | Sulfamic acid | 99 | 4-9 | 4-9 | pH < 1 |
| Total | | | | 100 | |

Formula #5 - 3.47% (w/w) AMCOL A based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 6 | 3.47 | 57.83 | |
| | (6% AMCOL A) | | | | |
| 2 | Sodium xylene | 40 | 0-7 | 0-7 | |
| | sulfonate | | | | |
| 3 | Sulfamic acid | 99 | 4-9 | 4-9 | pH < 1 |
| Total | | | | 100 | |

Formula #5 formulated with AMCOL aluminosilicates provides a viscous formulation and non-dripping foam on a vertical substrate, but the same formula when formulated with identical amount of laponite solids provides a highly dripping spray on a vertical substrate. When a hydrotope such as sodium xylene sulfonate is added to Formula #5, the formulation provides creamy, concentrated foam on a vertical substrate. Formulas #1-4 provide a wide spray pattern, which is not helpful for cleaning purposes and also leaves undue residue on the outskirts of spills while concentrated non-dripping foam is useful for more efficient cleaning of the substrate.

Formula #6 - 3.47% (w/w) AMCOL A based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 6 | 3.47 | 57.83 | |
| | (6% AMCOL A) | | | | |
| 2 | Sodium xylene | 40 | 0-7 | 0-17.5 | |
| | sulfonate | | | | |
| 3 | Sulfamic acid | 99 | 4-9 | 4.9 | |
| 4 | Ammonyx LO | 30 | 0.1-1 | 0.33-3.33 | pH < 1 |
| Total | | | | 100 | |

Formula #6 is an example where the thickening of the formulation is obtained by synergy between amine oxide surfactant and the AMCOL aluminosilicates at the low pH of the formulations. Such synergy is not observed at higher pHs in the range 11-13. Effective thickening of the low pH formulations can be obtained at lower aluminosilicate solid level, in the presence of small amounts of amine oxide surfactants.

Formula #7 - 2.63-2.85% (w/w) AMCOL HA based

| | | Raw | Active, | Weight, | |
|---|---|---|---|---|---|
| Phase | Ingredient | Active % | % | % | |
| 1 | Aluminosilicate pregel | 6 | 2.85-2.63 | 95-87.5 | |
| | (3% AMCOL HA) | | | | |
| 2 | Sodium xylene | 40 | 2-5 | 5-12.5 | pH ~1.9 |
| | sulfonate | | | | |
| Total | | | | 100 | |

Formula #7 is a sprayable shear thinning formula containing protonated AMCOL aluminosilicates in the range 2.6-2.9% (w/w) solids. This formula with the hydrotope provides a foaming spray on a surface and has natural anti-microbial functional properties. If a thicker version of this formula is desired, then adding 0.1-1% (w/w) of amine oxide surfactants helps in thickening the formula and also providing vertical cling to a substrate like. Such a sprayable, shear thinning and thixotropic formula is represented by Formula #8.

Formula #8 - 2.0-2.58% (w/w) AMCOL HA based

| Phase | Ingredient | Raw Active % | Active, % | Weight, % | |
|---|---|---|---|---|---|
| 1 | Deionized water | | | qs | |
| 1 | Aluminosilicate pregel | 6 | 2-2.84 | 94-66.67 | |
| | (3% AMCOL HA) | | | | |
| 2 | Sodium xylene | 40 | 2-5 | 5-12.5 | |
| | sulfonate | | | | |
| 3 | Ammonyx LO | 30 | 0.1-1 | 0.33-3.33 | pH ~3.55 |
| Total | | | | 100 | |

Mixed metal hydroxides or layered double hydroxides are layered Poly(magnesium-aluminum-oxide-hydroxide) particles (diameter ˜0.1 microns), commercially known as MMH and sold as Polyvis II by SKW/Degussa/BASF. These particles are positively charged particles and thereby can form network structure with negatively charged basal surfaces of clay particles. AMCOL (A+C), AMCOL (B+C) and AMCOL (V+C) pregels may be used to prepare these low pH formulations, where the highly positively charged additive C (MMH) particles are electrostatically attracted to the negatively charged clay basal surface particles and thereby build up the network structure. Stronger the electrostatic interactions, the formulations will be able to tolerate more salt and ionic strength before the structure will collapse due to the suppression of the electrical double layers around the clay particles. The additive C may be added at 0.1-0.7% on aluminosilicates. These pregels are also very useful at high pH, where the surface charge on the additive C (MMH) particles are not that high (may be slightly negative or positive depending on solution pH) and the attractive/repulsive force between these particles and the negatively charged clay surface is less strong. The aluminosilicate and additive C mixture may not be therefore able to tolerate a very high ionic strength in high pH formulations as the network may collapse easily and lead to longer term instability of the formulations. Other positively charged particles such as titanium dioxide, alumina, cationic polymers etc. may be also used to boost the viscosity of clay based formulations by helping network formation among the positively charged and negatively charged particles. However, there an optimum concentration of positively charged particles beyond which a high level of flocculation will cause instability of the formulation.

Formula #9 - 2.6% (w/w) AMCOL (A + C) based

| | | Raw | Active, | | |
|---|---|---|---|---|---|
| Phase | Ingredient | Active % | % | Weight, % | |
| 1 | Deionized water | | | qs | |
| 1 | Aluminosilicate pregel | 4.58 | 2.6 | 56.77 | |
| | (4.58% AMCOL A + | | | | |
| | C) | | | | |
| 2 | Sodium xylene | 40 | 2-5 | 5-12.5 | |
| | sulfonate | | | | |
| 3 | Sulfamic acid | 99 | 4-9 | 4-9 | pH < 1 |
| Total | | | | 100 | |

Most of the formulas have pH as low as 0.5, with Formula #9 having a pH of 0.7

Summary of viscosity and foam characteristics of low pH formulations with AMCOL aluminosilicate pregels.

| | | % Sulfamic | % Amine | % Xylene | % Oxalic | % aluminosilicate | |
|---|---|---|---|---|---|---|---|
| Formula # | % SLS | acid | Oxide | sulfonate | acid | solids | Pregel type |
| 2.6% AMCOL B | 2 | 7 | 0 | 0 | 2 | 2.6 | AMCOL B |
| 2.6% AMCOL A | 2 | 7 | 0 | 0 | 2 | 2.6 | AMCOL A |
| 2.6% AMCOL V | 2 | 7 | 0 | 0 | 2 | 2.6 | AMCOL V |
| 3.47% AMCOL B | 2 | 7 | 0 | 0 | 2 | 3.47 | AMCOL B |
| 3.47% AMCOL A | 2 | 7 | 0 | 0 | 2 | 3.47 | AMCOL A |
| 3.47% AMCOL V | 2 | 7 | 0 | 0 | 2 | 3.47 | AMCOL V |
| 3.29% AMCOL B | 1.46 | 7 | 0 | 0 | 1.46 | 3.6 | AMCOL B |
| 4.9% AMCOL B | 2 | 7 | 0 | 0 | 2 | 4.9 | AMCOL B |
| 2.6% AMCOL HA + | 2 | 7 | 0 | 0 | 2 | 2.6 + 0.87 | AMCOL HA + |
| 0.87% AMCOl A | | | | | | | AMCOL A |
| 2.6% AMCOL HB + | 2 | 7 | 0 | 0 | 2 | 2.6 + 0.87 | AMCOL HB + |
| 0.87% AMCOl B | | | | | | | AMCOL B |
| 2.6% AMCOL HA + | 2 | 7 | 0 | 0 | 2 | 2.6 + 1.73 | AMCOL HA + |
| 1.73% AMCOl A | | | | | | | AMCOL A |
| 2.6% AMCOL HB | 2 | 7 | 0 | 0 | 2 | 2.6 | AMCOL HB |
| 2.6% AMCOL HA | 2 | 7 | 0 | 0 | 2 | 2.6 | AMCOL HA |
| 6.94% AMCOL FLT | 2 | 7 | 0 | 0 | 6.94 | 6.94 | AMCOL B |
| 3.47% AMCOL B + | 2 | 7 | 0 | 0 | 2 | 3.47 | AMCOL B |
| 5% TiO2 on AMCOL B | | | | | | | |
| 3.47% AMCOL A + | 2 | 7 | 0 | 0 | 2 | 3.47 | AMCOL B |
| 6% TiO2 on AMCOL A | | | | | | | |
| 3.47% AMCOL A in | 0 | 7 | 0 | 0 | 0 | 3.47 | AMCOL A |
| formula #4 | | | | | | | |
| 3.47% AMCOL A in | 0 | 7 | 0 | 5 | 0 | 3.47 | AMCOL A |
| formula #5 | | | | | | | |
| 3.47% AMCOL A in | 0 | 7 | 0.3 | 5 | 0 | 3.47 | AMCOL A |
| formula #6 | | | | | | | |
| 2.6% AMCOL (A + C) | 0 | 7 | 0 | 5 | 0 | 2.6 | AMCOL (A + C) |
| in formula #9 | | | | | | | |
| 2.6% AMCOL HA in | 0 | 7 | 0 | 5 | 0 | 2.6 | AMCOL HV |
| formula # 7 | | | | | | | |
| 2.6% AMCOL HV in | 0 | 7 | 0 | 5 | 0 | 2.6 | AMCOL HA |
| formula #7 | | | | | | | |
| 2.6% AMCOL HA in | 0 | 7 | 0.8 | 5 | 0 | 2.58 | AMCOL HV |
| formula # 8 | | | | | | | |
| 2.6% AMCOL HV in | 0 | 7 | 0.8 | 5 | 0 | 2.58 | AMCOL HA |
| formula #8 | | | | | | | |
| 3.47% Laponite | 2 | 7 | 0 | 0 | 2 | 3.47 | laponite |

| | | | | Degree of | |
|---|---|---|---|---|---|
| | Viscosity at | Viscosity at | Viscosity at | shear | |
| Formula # | 0.5 rpm | 0.1 rpm | 200 rpm | thinning | Foam quality |
| 2.6% AMCOL B | 14240 | 59600 | 89 | 160.00 | borderline acceptable |
| 2.6% AMCOL A | 16400 | 70000 | 101.6 | 194.38 | borderline acceptable |
| 2.6% AMCOL V | 16480 | 56400 | 90.4 | 196.72 | little dripping |
| 3.47% AMCOL B | 19360 | 76000 | 99.6 | 251.85 | some driping |
| 3.47% AMCOL A | 31200 | 139200 | 158.6 | 184.14 | no drip |
| 3.47% AMCOL V | 40800 | 168000 | 162 | 341.01 | no drip |
| 3.29% AMCOL B | 14400 | 58800 | 78.2 | 173.58 | little driping |
| 4.9% AMCOL B | 74000 | 348000 | 217 | 104.02 | little driping |
| 2.6% AMCOL HA + | 20240 | 94000 | 116.6 | 64.04 | borderline acceptable |
| 0.87% AMCOl A | | | | | |
| 2.6% AMCOL HB + | 7760 | 35200 | 74.6 | 103.19 | dripping |
| 0.87% AMCOl B | | | | | |
| 2.6% AMCOL HA + | 20240 | 94000 | 116.6 | 240.20 | no drip |
| 1.73% AMCOl A | | | | | |
| 2.6% AMCOL HB | 5520 | 26000 | 86.2 | 240.20 | dripping |
| 2.6% AMCOL HA | 8400 | 39600 | 81.4 | 103.19 | dripping |
| 6.94% AMCOL FLT | 19120 | 102400 | 79.6 | 240.20 | no drip |
| 3.47% AMCOL B + | 26000 | 114400 | 110.6 | 235.08 | little dripping |
| 5% TiO2 on AMCOL B | | | | | |
| 3.47% AMCOL A + | 57200 | 297000 | 198 | 288.89 | no drip |
| 6% TiO2 on AMCOL A | | | | | |
| 3.47% AMCOL A in | 237200 | 1008000 | 944 | 251.27 | no drip |
| formula #4 | | | | | |
| 3.47% AMCOL A in | 131200 | 378000 | 494 | 265.59 | no drip |
| formula #5 | | | | | |
| 3.47% AMCOL A in | 35200 | 116000 | 1098 | 32.06 | no drip |
| formula #6 | | | | | |
| 2.6% AMCOL (A + C) | 28000 | 57000 | 130 | 215.38 | no drip |
| in formula #9 | | | | | |
| 2.6% AMCOL HA in | 51600 | 178000 | 210.5 | 245.13 | no drip |
| formula # 7 | | | | | |
| 2.6% AMCOL HV in | 5800 | 24000 | 93 | 62.37 | no drip |
| formula #7 | | | | | |
| 2.6% AMCOL HA in | 7000 | 36000 | 133 | 52.63 | no drip |
| formula # 8 | | | | | |
| 2.6% AMCOL HV in | 3400 | 19000 | 85 | 40.00 | no drip |
| formula #8 | | | | | |
| 3.47% Laponite | 25 | 25 | 25 | 1.00 | very dripping |

### Comparison of Base Clays

The effectiveness of AMCOL purified aluminosilicates is easily observed by comparing one such aluminosilicate, AMCOL V, with a regular unpurified AMCOL bentonite, and a synthetic hectorite such as laponite. Three base clays have been compared against each other: 3% AMCOL bentonite (unpurified), 6% AMCOL V (purified and ion-exchanged in Na-form), and 3% laponite. The aluminosilicate pre-gels were prepared in deionized water and were then adjusted to the desired pH with NaOH or HCl solution. Similarly, NaCl solution of a particular strength was added to increase the salt concentration on clay in another set of pre-gel formulations, maintained at the native pre-gel pH of ˜10. The concentration of solids in the adjusted final pH/salt containing pre-gel was corrected for any dilution due to the addition of base or acid or salt solution. The effects of pH and salt on each of these clays are demonstrated in the FIGS. 23-26. In FIG. 23, the left Y-axis represents the viscosity axis of the AMCOL bentonite (unpurified) and AMCOL V, while the right secondary Y-axis represents the viscosity axis for the laponite only. The AMCOL V or purified clay has a high low shear (0.5 rpm) viscosity over a wide range of pH compared to unpurified bentonite and the synthetic laponite. The synthetic laponite performs poorly at pHs lower than 7, while the regular bentonite exhibits some viscosity only at very low and very high pHs.

The degree of shear thinning as described by the ratio of viscosity at 0.5 rpm to viscosity at 200 rpm in this disclosure vs. pH for each of the clays is also shown in FIG. 24. It is evident from FIG. 24 that AMCOL V has a high degree of shear thinning over a wide range of pH compared to the other two clays, particularly at extremely low and high pHs. All AMCOL purified aluminosilicates AMCOL A, AMCOL B, AMCOL V exhibit similar behavior over a wide range of pH values. The synthetic laponite is only shear thinning at pH values higher than 7 but the laponite formulations do not regain structure as fast as the AMCOL V containing formulations since the latter are more thixotropic in nature. A high degree of shear thinning of rheology modifiers is very desirable when viscous formulations at rest are required to be highly shear thinning and sprayable at high shear.

The effects of salt and ionic strength on the same 3 clays are illustrated in FIG. 25. Again, it is apparent from this work that AMCOL V can tolerate a high level of salt and still maintain a high enough viscosity over a much wider range of salt concentration, compared to synthetic laponite and the unpurified bentonite. The laponite can tolerate only up to 5% salt on clay while AMCOL V can maintain consistently high viscosity up to 40% salt on clay. AMCOL purified aluminosilicates AMCOL A, AMCOL B, AMCOL V exhibit similar behavior. The regular bentonites have salts/impurities associated with them and thereby cannot tolerate as high level of salt as the purified and totally salt-free AMCOL V. Although the viscosity of 3% regular bentonite pre-gel is quite low at high salt concentration, its degree of shear thinning is better than the synthetic laponite over the entire range of salt concentration.

What is claimed is:

1. A foaming cleaning composition comprising about 0.5 to about 9% by weight of a layered phyllosilicate, more preferably from about 0.5 to about 7% by weight of a layered phyllosilicate, about 0.1 to about 5% of a surfactant, and a pH-adjusting agent selected from the group consisting of organic and inorganic acids and mixtures thereof, said compositions having a pH of about 0.1 to about 4.0, and wherein the composition has resistance to dripping on a vertical substrate.

2. The composition of claim 1, wherein the layered phyllosilicate is selected from the group consisting of smectite clays, montmorillonite clays, bentonite clays, sepiolites, hectorites, ion-exchanged and surface modified montmorillonite clays in sodium or protonated forms, attapulgites, and mixtures thereof.

3. The composition of claim 1, further including about 0.1 to about 10% of a hydrotope, 0.1-15% of a solvent.

4. The composition of claim 1, wherein the pH-adjusting agent includes an acid selected from the group consisting of HCl, phosphoric acid, phosphonic acid, sulfamic acid, oxalic acid, formic acid, citric acid, hydroxyacetic acid, nitrilotriacetic acid, malic acid and combinations thereof, and the composition has a pH between 0.1-4, or more preferably less than or equal to 1.0.

5. The composition of claim 1, further including a hydrotope in a weight ratio of at least 1:1 based on an amount of anionic surfactant in the composition, wherein the pH is about 0.1 to about 4.

6. The composition of claim 1, comprising about 0.5 to about 4% by weight of a montmorillonite clay; about 0.1 to about 1% by weight of a nonionic amine oxide surfactant; about 2 to 7% by weight of a hydrotope; and about 0.1 to about 15% of one or more ethers, propoxy ethanol or propoxy propanol as solvents.

7. The composition of claim 1, comprising about 0.5 to about 4% by weight of a montmorillonite clay in protonated form; about 0.1 to about 1% by weight of an amine oxide surfactant; about 2 to 7% by weight of a hydrotope to form a foaming, sprayable, and non-drip formulation at pH 2-4 for sanitizing surfaces.

8. The composition of claim 1, comprising about 0.5 to about 4% by weight of a montmorillonite clay; about 0.1 to about 1% by weight of an amine oxide surfactant; about 0.25 to about 15% by weight acid; about 2 to 7% by weight of a hydrotope; and about 0.1 to about 15% of one or more glycol ethers, and the rest deionized water.

9. The composition of claim 1, further including mixed metal oxides/hydroxides in the clay pre-gel to increase a viscosity of the composition and provide shear thinning and non-drip to the low pH formulation.

10. The composition of claim 1, further including positively charged particles selected from the group consisting of mixed metal hydroxides (MMH), alumina, titanium dioxide, a cationic polymer, cationic surfactant, and an amine oxide nonionic surfactant for interaction with the negatively charged clay platelet surfaces of the phyllosilicate particles thereby boosting a network structure of the composition.

11. The composition of claim 1, where the phyllosilicate pre-gels contain non-extending polymers selected from the group consisting of xanthan gum, cellulosics, guar gum, locust bean gum and combinations thereof to provide an increase in viscosity.

12. The composition of claim 1, where the phyllosilicate pre-gels contain optical brighteners such as TiO₂ in an amount of 0.5-15% (w/w) based on the weight of clay and said brightener having a particle size of 0.2-0.3 micron to provide a white formulation and a whiter foam.

13. The composition of claim 1, where both pre-gels and the low pH formulations are sufficiently viscous for suspension of negatively or positively charged pigments, optical brighteners, and other aesthetic pigments such as colored pigments (colored dye-clay complexes) or pearlescent mica. The positively charged pigments such as TiO2 at low pH, can interact with the negatively charged clay and may be used at an optimum level of 4-8% by weight on clay to prevent excessive flocculation and instability of the formulation.

14. The composition of claim 1, where the phyllosilicate has a size, surface charge, distribution of charge, and charge density to achieve an optimum level of flocculation.

15. The composition in claim 1, where the pre-gel formulations are prepared with phyllosilicate particles having a size of about 1 micron to about 2 microns such that the pre-gel compositions are beige to brownish or greenish colored and yet provide white to off-white foams due to the size of the phyllosilicate particles generated during the efficient dispersion of the phyllosilicate in the pre-gel state.

16. The composition in claim 1, where the high shear viscosity of the phyllosilicate pre-gel compositions is in the range 100-800 cP, more preferably in the range 140-500 cP, and most preferably in the range 150-350 cP, measured at 0.5 rpm with spindle 3 or 4 in a Brookfield Rheometer.

17. The composition in claim 1, where the low shear viscosity of the formulation with the phyllosilicate pre-gel compositions is in the range of 3500-100,000 cP, more preferably in the range of 10,000-60,000 cP, and more preferably in the range of 15,000-45,000 cP, measured at 0.5 rpm with spindle 3 or 4 in a Brookfield Rheometer.

18. The composition of claim 1, where the degree of shear thinning of the formulations as defined by the ratio of viscosity at 0.5 rpm to the viscosity at 200 rpm in the range of 10-400, preferably in the range of 40-350, more preferably in the range of 140-350.

19. The composition of claim 1, where the phyllosiliate pre-gels are highly thixotropic and highly shear thinning at high shear, but regain sufficient viscosity at low shear such that the foam from the composition is non-dripping on a vertical surface.

20. The composition of claim 1, where all particles are above 100 nm in particle size and, therefore, are not nano particles.

21. The composition of claim 1, comprising less than about 2% by weight of volatile organic compounds.

22. The composition of claim 21, comprising less than about 0.5% by weight of volatile organic compounds.

23. The composition in claim 2, where the phyllosilicates have a cation exchange capacity (CEC), in the range of 25-160 meq/100 g, and are in a form selected from 100% sodium exchangeable cations, 100% protonated forms, and mixed exchangeable cations selected from the group consisting of sodium, calcium, and magnesium or protons.

24. The composition of claim 1, wherein the pH-adjusting agent is an inorganic or organic acid or a combination of these, and wherein the composition has a pH of less than about 3.0.

25. The composition of claim 1, wherein the pH-adjusting agent is a strong acid, and wherein the composition has a pH of less than about 1.0.

26. The composition of claim 7, wherein the pH-adjusting agent the protonated montmorillonite itself, and wherein the composition has a pH of 2-4.

27. The composition of claim 7, wherein the hydrotype is selected from the group consisting of sodium xylene sulfonates, sodium cumene sulfonates, sodium toluene sulfonates, ethanol, isopropanol, propylene glycol, polyethylene glycol ethers, alkyl polyglucosides.

28. The composition of claim 1, wherein the bleaching agent is selected from the group of organic and inorganic acids, which also act as partial whitener for the phyllosilicates themselves.

29. A method of providing sprayability and foam in a composition having a pH in the range of 0.1-4.0 that contains about 2 to about 10% by weight of a hydrotope and an anionic surfactant, comprising adding a hydrotope to said composition in an amount of at least a weight ratio of 1:1 based on the weight of anionic surfactants in the composition.

30. The composition of claims 8, wherein the hydrotype is selected from the group consisting of sodium xylene sulfonates, sodium cumene sulfonates, sodium toluene sulfonates, ethanol, isopropanol, propylene glycol, polyethylene glycol ethers, alkyl polyglucosides.
